(19) United States
(12) Patent Application Publication
(10) Pub. No.: US 2011/0161227 A1
(43) Pub. Date: Jun. 30, 2011

(54) AUTOMATED DROP-OFF ASSISTANCE SYSTEM AND METHOD

(75) Inventor: Louis A. Santo, JR., Dillsburg, PA (US)

(73) Assignee: IM Marketing Concept LLC, Grantham, PA (US)

(21) Appl. No.: 12/649,457

(22) Filed: Dec. 30, 2009

(51) Int. Cl. G06Q 10/00; G06Q 20/00; G06Q 50/00; G06F 3/041; H04W 4/12; G06F 3/01; B65D 27/06

(52) U.S. Cl. 705/40; 705/305; 345/173; 455/466; 715/733; 229/300

(57) ABSTRACT

An automated system for drop-off and pick-up for repair, return or exchange of tangible items including a secure drop-off/pick-up area for the items, a computer and software to manage the data for the system, and a user interface to facilitate automated notification for responsive communication between the user and the service provider to describe service or repair required, provide quotations, request and receive additional information and notify the customer on completion of the service and scheduled maintenance using automated voicemail recording, and/or text messaging through a cellular telephone, email, PDA or iPhone using a web based applet.

### FIELD OF THE INVENTION

The present invention relates to an automated drop-off service system for repair, return and exchange of tangible items. This system includes a secure drop-off/pick-up area for the items, a computer and software to manage the data for the system, and a user interface to facilitate automated notification for responsive communication between the user and the service provider to describe service or repair required, provide cost quotations and present work orders as well as notify the customer on completion of the service using automated voicemail recording, and/or text messaging through a cellular telephone, email, PDA or iPhone using a web based applet.

### BACKGROUND OF THE INVENTION

The traditional method of dealing with a service related business has been to interact with the employees during the company's business hours to complete the service transaction. This interaction can be tedious and can result in the customer having to be inconvenienced by the company's specific operating hours, possibly having to wait to be helped, wait while repair is completed or be delayed because a knowledgeable enough employee is not immediately available during the service transaction. It can be especially inconvenient when the service simply requires its customer to drop-off or pick-up the items to be repaired, returned, or exchanged and the nature of the service to be effectively communicated. By removing the face to face encounter of the customer and employee from the service side of these routine service drop-offs and pick-ups, and instead providing an automated notification communication link between the customer and service provider, the customer can save time and can more accurately communicate information on the service required and the service provider can save time and money.

The use of a communication line for a customer at the point of drop-off of an item for a service transaction is known in the prior art such as in Lohrey et al. U.S. Pat. No. 4,803,348 that describes a system for automating laundry or dry cleaning services. In this disclosure a telephone system was available at the time of drop-off of the clothing items in order to discuss problems, complaints and special requests; however this approach may require a person to be available to receive the telephone calls or if a message is recorded during non-business hours there may be a longer delay before receipt of the message by the service provider and there is no confirmation from the service provider that the message was received. The Lohrey et al. patent also fails to disclose any further communication for additional information or notification to the customer at the completion of the services.

### OBJECTS AND SUMMARY OF THE INVENTION

The invention relates to an automated drop-off system for retail services, such as repair services (e.g. for automobiles, electronic devices and other various machinery), rental services (e.g. for cars, video/audio media and other various equipment), cleaning services (e.g. for laundry, dry cleaning and cars), and return services (e.g. for clothing and other various goods). The invention includes a simplified method for completing the drop-off transaction by providing one or more methods to initiate the transaction, establishing a contact platform for an automated notification system for communication between the customer and service provider on the service to be or that has been performed and by providing a secure and direct means to pay for the transaction. A convenient, efficient and effective user interface for both the customer and the service company improves the communication and satisfaction of the customer and greatly reduces the risk of unnecessary repairs due to miscommunication between the customer and employees of the service company.

At the initiation of a transaction of the automated drop-off system the data system is accessed and the customer is presented with a set of menu items to disclose the identification of the customer, the item being left for service or exchange, the information required for service and instructions to the customer on how to properly secure the item in the drop area. A receipt or work order is presented to the customer with information on the service to be performed and options for required maintenance of the item that the customer may also authorize. The work order is then printed recording the transaction. The customer is then prompted using a menu item for the contact platform to be used to establish communication between the customer and the service provider. In choosing the contact platform the system sets up an automated notification link and the system immediately notifies the service provider that an item has been dropped off or picked up and a notification for confirmation of this transaction is sent to the customer through the selected contact platform, such as a recorded voice message, text message using email, or a cellular phone, or an alarm notification through a web applet using sound notification or an icon display on a PDA or iPhone.

The use of the automated drop-off system allows the service provider to improve scheduling of work because the proper information for service has been effectively communicated and similar service jobs in total time required or complexity can be grouped and prioritized based on current workload and parts availability. The automated drop-off system also allows the service provider to immediately review the transaction and contact the customer if further information is needed. The customer is also not delayed in notification of costs or completion of repairs and the system may also provide to the customer notification of future appointments for scheduled maintenance of the item or vehicle.

It is an object of the present invention to automate the drop-off and pick-up aspects of service related businesses using a specified contact platform to provide automated notification for a more convenient and efficient system of completing these aspects of the transaction.

It is a still further object of the present invention to provide a system that allows the customer to drop-off/pick-up goods associated with the service during all hours of the day, even when the service provider is closed.

Another object of the present invention is to associate data with the good involved in the drop-off/pick-up, where the data can be modified by the customer, the service provider, and the server associated with this system to track, identify and relay information, convey instructions to both the customer and the service, and perform other functions associated with the good.

A further object of the present invention is to allow the data associated with the good to be analyzed, modified, or conveyed through different media, including a system kiosk, hardware connected to the server, a cell phone, a PDA, iPhone or the internet.

A still further object of the present invention is to relate the data associated with the good to past and future transactions involving the service and provide notifications. For example, in the auto repair service industry, the data can indicate what was done to the car in the past and can also schedule events in the future, e.g., oil changes and other scheduled servicing.

It is another object of the present invention for the system to have a user-friendly interface and software for the different mediums that deal with the data associated with the goods.

Yet another object of the invention is to provide an automated method and system for a user to drop-off a motor vehicle for service and notify the service station and for a user to be notified to pick up the motor vehicle after service is complete.

A further object of the invention is to provide an internet-based method of identifying the user, goods and service to be performed, and for allowing secure payment for the service performed.

The present invention relates to a system for automating the drop-off and pick-up steps for service of an item comprising a goods exchange area for receiving an item to be serviced, a user interface located near the goods exchange area comprising display means for presenting information to a user and input means for inputting information about the user and the item into the user interface, a server that communicates with the user interface, the server including memory for storing data associated with the item and software that directs communication between the user and the server through the user interface and an automated notification interface that notifies the user and the server of receipt, progress, completion of service to the item and notification of future appointments.

The present invention also relates to a method of automated drop-off by a user of a service item at a service provider comprising the steps of receiving the service item, providing a user interface having one of a direct user input and a remote user input platform including a visual display and an input device, presenting instructions on the visual display to the user and receiving identification and service item information from the user, presenting via the visual display a service selection menu and receiving instructions from the user regarding the service and a preferred notification platform for contacting the user, identifying the service required on the service item, preparing a work order and presenting the work order to the user via the visual display, receiving from the user an authorization notification of the work order and at least one of a key or code to permit access to the service item, and notifying the service provider of receipt of the authorization of the work order and service item.

These and other features, advantages and improvements according to this invention will be better understood by reference to the following detailed description and accompanying drawings.

### BRIEF DESCRIPTION OF THE DRAWINGS

FIG. 1 is a schematic block diagram of an embodiment of the system for an automated drop-off service of the present invention;

FIG. 2 is a schematic block diagram of the steps of one embodiment of the automated drop-off and pick-up service for the present invention;

FIG. 3 is a schematic block diagram of an embodiment of the system for an automated drop-off and pick-up service for motor vehicles; and

FIG. 4 is another schematic block diagram relating to the specific process of retrieving goods or a vehicle from the service provider.

### DETAILED DESCRIPTION OF THE INVENTION

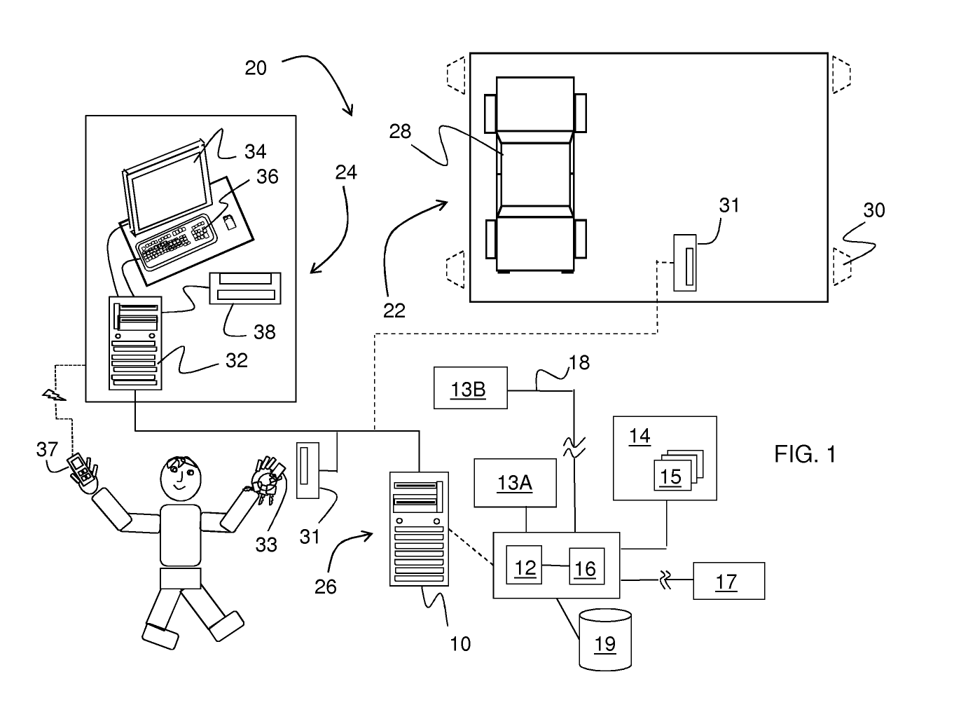

FIG. 1 shows in schematic block diagram form the automated drop-off system 20 of the invention. The automated drop-off system 20 contains the main elements of a goods exchange area 22, a user interface 24 near the goods exchange area 22, and a system server 26 that manages the information and data associated with the service item 28 and establishes communication between the customer and the service provider. Both customers and service personnel can access the goods exchange area 22 and the user interface 24, but only service personnel can directly access the server 26.

As shown in FIG. 1, the goods exchange area 22 is the location designated as a secure drop-off and pick-up area by the service provider that facilitates the operation of the automated drop-off system 20 of the present invention. This area 22 can vary from a parking lot for auto services to any appropriately sized container, for example, for video rental services or be simply a mail receiving location where an item for service is shipped to and received by the service provider. As previously noted, both customers and service personnel can access the goods exchange area 22, although the area may contain sections that have limited access for the service personnel only. The goods exchange area 22 may also have optional sensors 30 that collect data from the good itself when it is being dropped-off or picked-up. These sensors 30 could use technology such as radio-frequency identification (RFID) chips, bar-coding, or some other form of automatic identification technology as is known in the art. The sensors 30 could also be used to detect physical characteristics of the service item 28, such as the height, weight, or shape of the item. The sensors 30 may also simply be motion sensors that detect movement in the goods exchange area 22 and thereby trigger the automated drop-off system 20 to turn on.

In another embodiment of the present invention, the goods exchange area 22 and/or a user interface 24 can be equipped with an electronic reader 31 which reads an input card or key fob 33 carried by the user which contains either a magnetic identification number, bar code or other electronic, magnetic or optical readable indicia that instructs the system 20 to allow access to a customer information database in the system 20, or retrieves the user's information stored directly on the input card. In this manner the user's identification and personal information such as name, address, phone numbers, and even secured credit card information for billing purposes, can be displayed instantly to the user or at a touch of the finger, and quickly verified or changed by the user as necessary.

Alternatively, in case the input card or key fob is not available or working improperly, a user may utilize a password, I.D. number or some other secure variable that can be directly input through the display 34 or keyboard 36 of the user interface to identify and retrieve the user's specific personal information. The user identification code can be a phone number, a user supplied alpha-numeric password, a computer generated number, a random number, or a code derived from a variety of numbers or codes to create a unique user identification code for representing a specific user to the variety of network connected devices. The user identification code will be understood to also include the combination of account identification and password to enable the system 20 to authenticate the user to any account without the user having to repeatedly enter that specific data.

FIG. 1 also shows the user interface 24 at the goods exchange area 22 that facilitates communication between the customer and the system server 26. The user interface 24 includes a central processing unit (CPU) or processor 32, a display 34 for displaying information, input means for inputting information 36, and an optional printer 38. The user interface 24 is accessible by both the customer and the service personnel, where the customer will mainly input and receive information about their service item(s) 28 and the service personnel will generally repair and replenish the user interface 24 as needed. The user interface 24 may be a standalone kiosk or connected to a building, such as an outside portion of one of the buildings used by the service company. It is also to be appreciated that the user interface 24 may include a cell phone, PDA or other readily accessible wired or wireless personal communication device, also described below as a contact platform 37 through which the user can communicate, i.e. receive and send data to and from the system 20.

The display 34 for the user interface 24 can range from a simple light-emitting display to a touch-screen display for example in a kiosk. A touch screen display can function as both display 34 and input means such as a keyboard 36. The display 34 in interfacing with the user interface CPU 32 will through a series of menu options and input boxes convey information to the customer, and receive input information from the customer about the service item 28. The means for inputting information 36 at the user interface 24 can include, for example, a mouse, a keyboard, or a touch-screen device. This information on the service item 28 is communicated to the system server 26. The system server 26 includes a computer system 10 with a processor 12 and the automated drop-off system software 16. The system server may also have an item informational database 13 with data on all types of items serviced through the service provider and a service history database 14 with records 15 of all prior service completed on a specific item. Upon receiving information specific to the service item 28, the server 26 retrieves from the service history database 14 additional information either specific to the particular service item seeking service such as identification information of the service item, the customer and past repair work done, or retrieves general information about the service item from the item informational database 13. This database may be an internal database 13A or may be an external item database 13B accessed through the server 26 to an internet connection 18 to retrieve information on new items that have not been serviced before. This item information from the item informational database 13 is used to create menus and options that are presented through the user interface 24 to the user, for the user to make choices and enter information. For example, if the service item 28 is new and has not been serviced before, the customer enters the make of their automobile; the server 26 accesses information on the item from the external item informational database 13B through the internet connection 18 to retrieve list of models specific to that automobile manufacturer for the user to select from. A list of year of manufacture, options such as automatic or manual transmission, the color of the car and other features are retrieved and suggested to the user to either select from a menu option or enter through the keyboard 36 of the user interface 24. Through the menu selections and user inputs, the server 26 acquires all identification information necessary for the service item 28.

The user is then prompted to either confirm personal identification information such as the customer's name, address, and payment or warranty information, which has been retrieved from the service history database 14 or the input card 33 or the customer is prompted to enter or correct this information. The user is then prompted at the display 34 for information about the repair required for the service item. Upon receiving information on the repair from the user interface 24, the server 26 retrieves data from the item informational database 13 and presents a service selection menu and input boxes to allow the user to describe what the specific problem of the item is, enter information on past service from other service providers on the item, and select or enter what service is currently wanted; and/or enter other information relevant to the service transaction. The service selection menu also provides to the user information on estimates for time and costs for repair and may also through the server 26 access the inventory database 19 to check for current inventory levels of parts that are needed in the repair to properly estimate completion time.

The system server 26 communicates with the user interface 24 and also with the internal and external databases and systems of the service provider through a local area network connection. The system server 26 also includes an automated notification interface 17 that is linked with the automated drop-off system software 16 and the internal databases. Using the automated drop-off system software 16 and information provided by the customer and the service provider, the automated notification interface 17 generates notifications, cost estimates, quotations, and requests for information to facilitate immediate notification between the customer and the service provider. The contact platform for communication using the automated notification interface 17 would be established from a selection by the customer of a menu prompt on the display 34. When prompted, the customer would select the contact platform for notification through either recorded messages to the customer's telephone number or through text messaging, to a cellular phone, or by email, or through a PDA or iPhone using a web based applet. Because of the similarity in the types of messages communicated, the automated drop-off system software 16 may use templates and optional fields to personalize a message to a certain individual with specific content of the transaction and repair from the service history database 14. The contact platform may also be used to allow the customer to connect to the system server 26 remotely using a wireless or internet connection and provide the initial required information to the service provider and then complete the steps of either dropping off the item at the goods exchange area at a later time or mailing the item to the service provider or any other method whereby the service provider receives the service item. The notification interface 17 would then allow the service provider to send a confirmation to the customer upon receiving the item to be serviced. The user interface 24 is optionally connected to a printer 38 that may take the form, for example, of an inkjet printer, a laser printer, or a thermal printer. The printer 38 is used to print information relating to the service transaction for the customer to keep as a record.

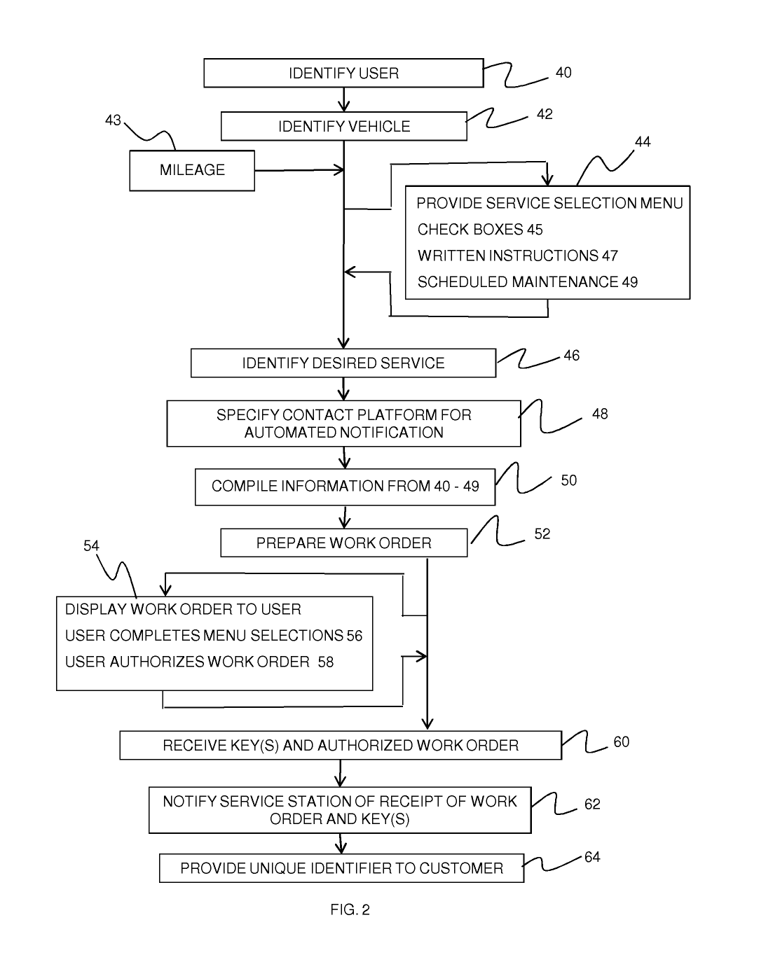

FIGS. 2, 3 and 4 illustrate an embodiment of the invention for use with motor vehicles for example, although other goods could also be used with this system. As shown in FIG. 2, the method of the present invention can include the steps generally accomplished by the software 16 of identifying the user 40, identifying the motor vehicle 42 and mileage 43 and providing a service selection menu to the user at step 44. This service selection menu can include check boxes 45 or other easily chosen indicia for common service tasks and for example routine scheduled maintenance 49 based on the cars mileage input by the user at 43 as well as identifying the desired service 46 from the check boxes 45 and any written instructions at 47. The user can be prompted to specify the contact platform 37 for the service station for the system to automatically contact and reply to the user at step 48. After compiling this information in a predefined format at step 50, the system then prepares a work order for the user to sign and/or authorize the service 52 in some manner. This work order is displayed to the user at step 54 and the user can complete a review by checking and/or un-checking specific check boxes corresponding to service descriptions on the work order at step 56. Completing the review the user authorizes the work order at step 58. The system and device is also configured to receive a key from the user and receive the authorization from the user for the work order 60, and notify the service and accounting/billing department of the service provider of the receipt of the work order and key 62 and providing a work order number or other unique service receipt identifier to the customer at step 64.

An important aspect of the present invention is that the system server 26 and software 16 prepares the work order at step 52 that can be presented to the user immediately at the display 34 or via the appropriate contact platform 37 upon the user's completion of information about the repair required for the service item. In an embodiment of the present invention the automated drop-off system software 16 takes the information provided in the service selection menu at 44 and which can allow the user to both pick from predefined service applications i.e. scheduled maintenance, and/or describe the specific problem or issue of the item through the interface, and compiles the information into the work order at 50 which can be presented directly, and immediately to the user at step 54 via the display 34, or over their desired contact platform 37. The user can approve the service at step 58 by indicating through the interface 24 or platform an authorization of the work order by checking an appropriately displayed icon or executing an instruction as prompted by the software 16 through the display 34.

The work order presented at step 54 can also display any recommended maintenance or tests on the item based for example on vehicle mileage entered by the user upon an appropriate prompt by the software 16. If this recommended maintenance or tests are to corresponding service entries, the user can either agree or not agree to such recommended maintenance or test prior to authorization of the work order. It is to be appreciated that such a step of choosing service can occur either at step 46 and/or at step 56 where the user is reviewing the work order prior to authorization. It is possible that each different service entry on the work order may be easily authorized or not by providing check boxes or icons which can be quickly displayed to the user and an authorization indication feature correspondingly associated with each service entry on the work order.

Once the work order is authorized by the user or customer, the keys can be received at step 60 and the work order can be directly forwarded to the technicians at step 62 without any intermediate personnel needing to have input to the work order. Also, the work order can be sent to the billing/accounting department so that the appropriate initial notation and accounting for service work can be undertaken. Generally, the customer is not charged, nor any billing to the client is provided until the service work is done. However, the early notification of the billing/accounting department facilities the final billing and invoicing of the customer, even where modifications and/or amendments may be made to the clients bill. The software 16 also schedules the next appointment or a tentative appointment, and even a reminder for the user prior to the next appointment, based on the input mileage and of information about the repair required for the service item.

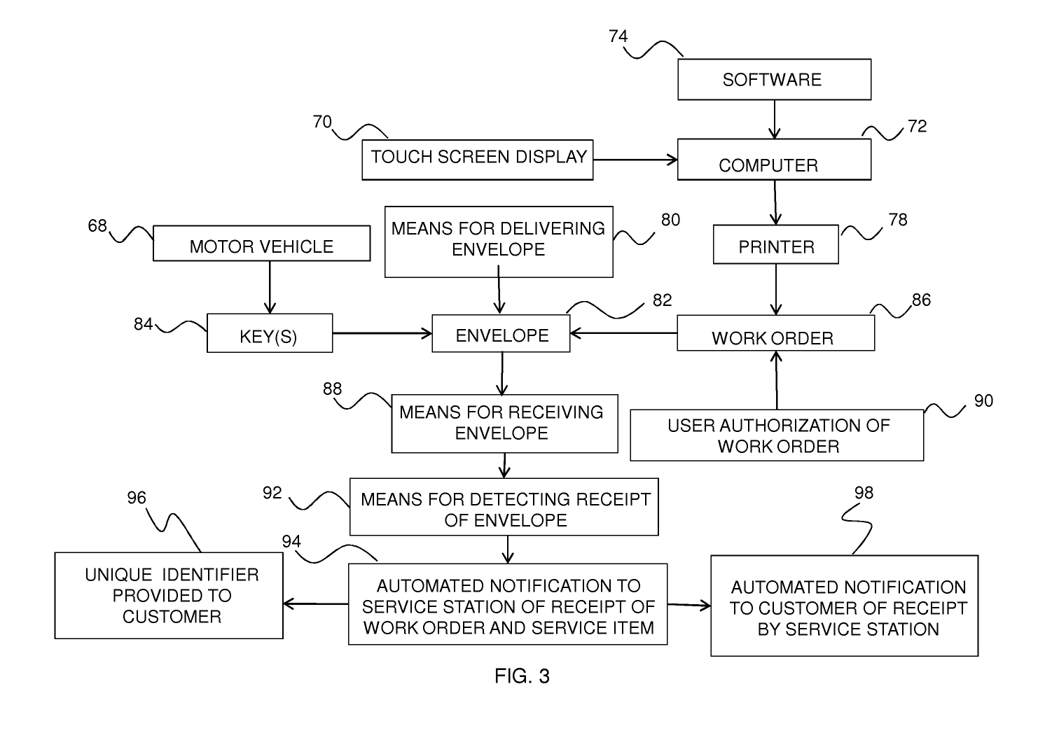

Another important feature of the automated drop-off system 20 is a secure method of transferring the item both from the customer to the service station and from the service station to the customer without the requirement of interaction between the customer and service personal. The automated notification interface 17 notifies the service provider immediately upon completion of the transaction, and the service provider acknowledges the transfer by sending an automated receipt of the transfer to the customer and by providing a unique identifier to the customer. In one embodiment of invention as shown in FIG. 3, the system is used for automated drop-off of a user's motor vehicle 68 for service at a motor vehicle service station. In this embodiment, the automated drop-off system includes a touch screen display 70 for presenting information to, and receiving information from the user, a computer 72 in communication with the touch screen display 70, the automated drop-off system software 74 running on the computer 72 for interacting with the user. As described above the software 74 and computer 72 may be connected with databases from a system server to include menu and optional input to present to the user for user identification, for identification of the motor vehicle 68, and for identifying the service desired by the user. The software further provides templates for preparing a work order 86 for the user. The work order 86 is presented to the user for review and the user is then prompted to specify a contact platform 37 and to provide an electronic signature to authorize 90 the service operations specified in the work order. The authorization 90 triggers a means for the service provider to receive a key 84 to receive the motor vehicle 68 from the user. The automated drop-off system may provide a secure envelope or drop box 82 for the user to insert the key 84 and a means for receiving the key by the service provider 88. The work order 86 may also be printed for the user to sign to provide user authorization 90, and may be placed into the envelope 82 with the key 84. The envelope 82 is then inserted into the means for receiving the envelope 88.

Alternatively, the work order 86 can be printed directly on the envelope 82 in order to facilitate clear identification of the motor vehicle keys 84. The means for delivering the envelope 80 to the user can be, for example, an envelope feeder, while the means for receiving the envelope 88 containing the key 84 can be any means which permit only authorized personnel to access the keys 84, for example, a drop box with a slot in the top, a hinged mechanism such as that found on U.S. Mail drop boxes, pneumatic tubes and the like. The system can also include means for detecting receipt 92 of the key 84, inside the envelope 82, from the user. For example, a weight sensor, a photodetector, metal detector, scanner, bar code reader and the like.

After the user delivers the motor vehicle key 84, the service station is automatically notified, by the automated notification system 94 of receipt of the work order, and that the user has dropped off a motor vehicle 68 for service. The internal communication to the service station using the automated notification system 94 can also be from a number of different contact platforms 37 in order to facilitate rapid notification to the service provider, for example, of an automated voice recording on a phone call, an email message, or an alarm notification to a PDA or iPhone using a web applet. Upon receipt by the service station of the motor vehicle, an automated notification is sent on the specified contact platform 37 to the customer 98 confirming receipt by the service station.

In order for the customer to securely pickup the vehicle upon completion of service, a unique identifier 96, such as an alphanumeric character string, a picture of a readily identifiable object, a customer selected question and answer, a sensor, or a printed barcode is provided to the customer. This identifier must be entered into the automated drop-off system in order for the customer to pick up the vehicle as described in more detail below.

In another embodiment of the invention, many of the steps can be accomplished remotely in advance of the user dropping off the vehicle 68, for example, through an internet-based or wireless-based communications contact platform 37. This would allow users to do many of the preliminary steps from a remote electronic device such as a computer, cellular phone, PDA, iPhone and the like. In this embodiment, the computer 72 is remotely accessible to the user and the software 74 includes instructions for web-based interaction with the user allowing one or more of identifying the user 40, identifying the motor vehicle 42, identifying the desired service 46, specifying a contact platform 37 for the service station to contact the user regarding the service 48 and preparing a work order 52 for the user. The user is then provided with the unique identifier 64 in the form of a code or alternatively a barcode that identifies the service item and user identification when the user arrives at the goods exchange area 22 and a work order is printed, authorized by the user 58, and the keys to the motor vehicle are securely placed in an envelope 82 or drop box.

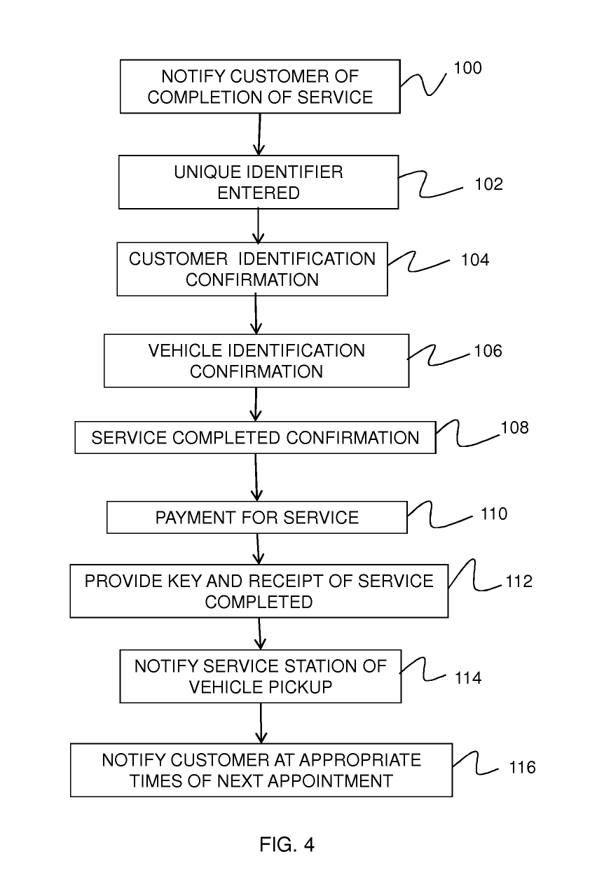

When service of the vehicle is completed the user is automatically notified that the vehicle is ready for pickup. In order to securely identify the user, when the user desires to pick up the vehicle after service is complete, the user must input the unique identifier 96 into the computer system 72 before having the key 84 to the vehicle delivered. The method of the customer picking up the vehicle may include the steps that are shown in FIG. 4. These steps are: the automated drop-off system automatically notifies the client of completion of the repair 100, the unique identifier is entered into the computer system 102, the customer is identified and the customer must provide an input to confirm their proper identification 104, the customer must further provide an input to confirm the proper identification of the vehicle 106 and the proper identification of the service performed 108, payment by the customer for the service 110, the key to the vehicle and a receipt of the service performed is dispensed to the customer 112, the service station is automatically notified of pick up of the vehicle 114 and automatic notifications of future service appointments or required maintenance are provided to the customer 116.

The automatic notification to the customer of completion of service using the contact platform 37, allows the customer to pick up the vehicle in the shortest amount of time that is convenient for them, improving customer satisfaction. The pick up of the vehicle is secure because only the customer has the unique identifier 96 which is required to allow access to the keys 84 of their vehicle 68. This can be accomplished, for example, by having a unique identifier 96, such as an alphanumeric character string or a picture of a readily identifiable object, or a barcode or sensor that must be swiped through a scanner to allow proper identification of the customer. If an alphanumeric code or picture identifier, the user must input the identifier into the computer through the touch screen display 70. The user is then prompted with their name and address, and must select to confirm that the identification is correct 104. The user is then prompted for the identification of their vehicle 106 and the identification of the service 108 that was performed. With the use of a unique identifier 96 and the prior steps of receipt of the correct keys properly identified, there is little chance that the system could present an incorrect identity of a customer or vehicle, however added security measures that remove the human element of error may be included; such as the customer being prompted with a personal question and answer that was selected by the customer when dropping off the vehicle to further securely identify that the proper customer is picking up the vehicle. If there are issues the automatic notification system could immediately contact a service representative to assist a customer. The customer then completes a secure payment process 110 to pay for the service provided.

Proper confirmation of the identity of the customer and vehicle would allow the keys 84 to the vehicle 68, and a receipt of the service performed 112 to be provided to the customer. The keys 84 may be ejected from a secure dispensing unit connected to the computer system 72 or alternatively from an envelope dispensing unit similar to that described above where the keys and receipt are in the properly identified envelope. The customer will then access their vehicle that will be parked proximate to the touch screen display 70 or alternatively the unique identifier may provide the customer access to a restricted access part of the goods exchange area 22 where the customer may pick up their vehicle.

The integration of the automated drop-off system with both external and internal databases allows for service history and manufacturer maintenance requirements for a specific service item to be uploaded in the system. The automated notification system 17 provides for notification of scheduled required maintenance and future appointments 116 to be sent to a customer at appropriate time intervals to help ensure that a vehicle or other service item is properly maintained. Appointments may be scheduled based on complexity of the maintenance and the proper inventory of required maintenance parts as well as confirmation by the customer of availability for a future appointment.

Since certain changes may be made in the above-described invention, without departing from the spirit and scope of the invention herein involved, it is intended that all of the subject matter of the above description or shown in the accompanying drawings shall be interpreted merely as examples illustrating the inventive concept herein and shall not be construed as limiting the invention.

### PARTS LIST

10 System Server Computer System
12 System Server Processor
13A Internal Item Informational Database
13B External Item Informational Database
14 Service History Database
15 Service History Records
16 Automated Drop-off System Software
17 Automated Notification Interface
18 Internet Connection
19 Inventory Database
20 Automated Drop-off Service System
22 Goods Exchange Area
24 User Interface
26 System Server
28 Service Item
30 Goods Exchange Area Sensors
31 Electronic Reader
32 User Interface CPU
33 Key Fob or Input Card
34 Display
36 Input Means
37 Contact Platform
38 Printer
40 Identifying the User
42 Identifying the Motor Vehicle
43 Mileage
44 Provide Service Selection Menu
45 Check Boxes
46 Identifying the Service
47 Written Instructions
48 Specifying the Contact Platform for Automated Notification
49 Scheduled Maintenance
50 Compile Information
52 Prepare Work Order
54 Display Work Order to User
56 User Completes Menu Selections
58 User Authorizes Work Order
60 Receiving Key and Authorized Work Order
62 Notifying the Service Station of Receipt of Key and Work Order
64 Providing Unique Identifier to Customer
68 Motor Vehicle
70 Touch Screen Display
72 Computer
74 Software
78 Printer
80 Means for Delivering Envelope to User
82 Envelope
84 Motor Vehicle Key(s)
86 Work Order
88 Means for Receiving the Envelope from the User
90 User Authorization of Work Order
92 Means for Detecting Receipt of the Envelope
94 Automated Notification to Service Station of Receipt of Item
96 Unique Identifier Provided to Customer
98 Automated Notification to Customer of Receipt by Service Station

I claim:

1. A system for automating the drop-off and pick-up steps for service of an item comprising:
a goods exchange area for receiving an item to be serviced;
a user interface located near the goods exchange area comprising display means for presenting information to a user and input means for inputting information about the user and the item into the user interface;
a server that communicates with the user interface, the server including memory for storing data associated with the item and software that directs communication between the user and the server through the user interface; and
an automated notification interface that notifies the user and the server of receipt, progress, completion of service to the item and notification of future appointments.

2. The system of claim 1, wherein the user interface comprises a touch screen display.

3. The system of claim 1, wherein the automated notification interface comprises using a voice recorded message on a telephone for notification.

4. The system of claim 1, wherein the automated notification interface comprises using text messaging on a cellular phone or email system for notification.

5. The system of claim 1, wherein the automated notification interface comprises using a web applet for notification through a PDA or iPhone.

6. The system of claim 1, further comprising a printer.

7. The system of claim 1, further comprising a secure method of transferring an object such as a code or key to permit proper identification and access to the service item.

8. The system of claim 1, further comprising a secure method of transferring payment for the service performed on the item.

9. The system of claim 1, wherein the user interface is remotely accessible to the user and the software includes instructions for web-based interaction with the user allowing one or more of identifying the user, identifying the motor vehicle, identifying the service, preparing a work order for the user and specifying a method for the service station to contact the user regarding the service.

10. A system for automated drop-off of a user's motor vehicle for service at a motor vehicle service station, comprising:
a touch screen display for presenting information to the user and receiving information from the user;
a computer in communication with the touch screen display;
software running on the computer for interacting with the user, the software including instructions for identifying the user, identifying the motor vehicle, identifying the service, preparing a work order for the user and specifying a method for the service station to contact the user regarding the service;
means for the service station to notify the user regarding the service; and
means for receiving a key to the motor vehicle from the user.

11. The system of claim 10, further comprising means for receiving payment from the user for the service.

12. The system of claim 10, wherein the software includes instructions for the user to specify a preferred method of notifying the user.

13. The system of claim 10, further comprising a printer, an envelope for receiving the key to the motor vehicle, means for delivering the envelope to the user, and means for receiving the envelope back from the user.

14. The system of claim 13, further comprising means for detecting receipt of the key from the user.

15. The system of claim 14, further comprising means for notifying the service station that the user has dropped off a motor vehicle for service.

16. The system of claim 15, further comprising means for securely identifying the user, and means for delivery of the motor vehicle key from the service station to the user after completion of the service.

17. The system of claim 16, wherein the means for securely identifying the user comprises an alphanumeric identifier sent to the user with the service completion notice.

18. A method of automated drop-off by a user of a service item at a service provider comprising the steps of:
receiving the service item;
providing a user interface having one of a direct user input and a remote user input platform including a visual display and an input device;
presenting instructions on the visual display to the user and receiving identification and service item information from the user;
presenting via the visual display a service selection menu and receiving instructions from the user regarding the service and a preferred notification platform for contacting the user;
identifying the service required on the service item;
preparing a work order and presenting the work order to the user via the visual display;
receiving from the user an authorization notification of the work order and providing to the user at least one of a key or code to permit access to the service item; and
notifying the service provider of receipt of the authorization of the work order and service item.

19. The method of automated drop-off by a user of an item for service at a service provider of claim 18, further comprising the steps of providing at least one of the service selection menu and work order a scheduled maintenance service item based on at least one of age of the item and frequency of use of the item; and
permitting the user a choice to include, or exclude the scheduled maintenance service item from the work order.

20. The method of automated drop-off by a user of an item for service at a service provider of claim 18, further comprising the steps of notifying user via the preferred notification platform at least one of a notification of receipt of work order by the service provider and a notification of completion of work order for the service item.
